(19) United States
(12) Patent Application Publication
(10) Pub. No.: US 2010/0273438 A1
(43) Pub. Date: Oct. 28, 2010

(54) RADIO COMMUNICATION APPARATUS AND RADIO COMMUNICATION METHOD IN MULTI-CARRIER COMMUNICATION

(75) Inventors: Akihiko Nishio, Kanagawa (JP); Masaru Fukuoka, Ishikawa (JP); Katsuhiko Hiramatsu, Kanagawa (JP); Masayuki Hoshino, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/303,695

(22) PCT Filed: Jun. 5, 2007
(86) PCT No.: PCT/JP2007/061369

§ 371 Date: Jun. 7, 2010

(30) Foreign Application Priority Data
Jun. 5, 2006 (JP) 2006-156432
Nov. 22, 2006 (JP) 2006-316145

(51) Int. Cl. H04B 7/02

(52) U.S. Cl. 455/101

(57) ABSTRACT

Provided is a radio communication device capable of preventing lowering of the frequency diversity effect when using the CDD (Cyclic Delay Diversity) in combination with the frequency diversity technique in a multi-carrier communication. In the radio communication device (100), a repetition unit (103) repeats each symbol to generate the same symbol, an S/P unit (104) converts a symbol string inputted in series from the repetition unit (103) into a parallel string, and an arrangement unit (105) arranges a plurality of symbols inputted in parallel to any of a plurality of sub-carriers constituting the OFDM symbol. Here, the arrangement unit (105) correlates a plurality of the same symbols generated by repetition to a cyclic delay in the CDD and arranges them to any of the sub-carries constituting each of the OFDM symbols at a sub-carrier interval based on the number of antennas and the delay amount of the CDD transmission.

### TECHNICAL FIELD

The present invention relates to a radio communication apparatus and a radio communication method in multicarrier communications.

### BACKGROUND ART

In the field of radio communication, especially in mobile communication, a variety of information such as image and data in addition to speech is transmission targets in recent years. It is anticipated that the demand for higher-speed transmission becomes further increased in the future, and, to perform high-speed transmission, a radio transmission scheme, which utilizes limited frequency resources more effectively and achieves high transmission efficiency, is required.

OFDM (Orthogonal Frequency Division Multiplexing) is one of radio transmission techniques, for meeting the demand. OFDM is one of multicarrier communication techniques, whereby data is transmitted in parallel using a large number of subcarriers, and it is known that OFDM provides high frequency efficiency and reducing inter-symbol interference under a multipath environment and is effective to improve transmission efficiency.

Moreover, in OFDM, the frequencies of a plurality of subcarriers where data is mapped are orthogonal to each other, so that it is possible to achieve the best frequency efficiency in multicarrier communications, and OFDM can be realized in a relatively simple hardware configuration.

Moreover, in OFDM, to prevent ISI (Intersymbol Interference), the tail part of an OFDM symbol is added to the beginning of that OFDM symbol as a cyclic prefix (“CP”). By this means, in the receiving side, ISI can be prevented as long as the delay time of a delay wave is within the time period of the CP (hereinafter “CP length”).

Further, in OFDM, the received quality of each subcarrier may significantly fluctuate depending on frequency selective fading due to multi-path. In this case, the signals mapped to the subcarriers in the position of a fading dip have poor received quality, and therefore error rate performances degrade.

Technologies for reducing degradation of error rate performances in OFDM include frequency diversity techniques, for example, repetition, distributed transmission and modulation diversity.

Repetition is the technique of generating a plurality of the same symbols by repeating (repetition), and transmitting a plurality of same symbols by mapping them to a plurality of different subcarriers or different times. By this repetition, it is possible to reduce the probability that a plurality of the same symbols all hit the fading dip, that is, it is possible to obtain frequency diversity effect, and reduce degradation of error rate performances.

Distributed transmission is a frequency diversity technique using a distributed channel formed with a plurality of different subcarriers dispersed over the entire band. By using a distributed channel, it is possible to reduce the probability that a plurality of symbols of the same distributed channel all hit the fading dip, that is, it is possible to obtain frequency diversity effect, and reduce degradation of error rate performances.

Moreover, in modulation diversity, after phase rotation is applied to modulated symbols, the I-channel components (i.e. in-phase components) and the Q-channel components (i.e. quadrature components) are mapped to different subcarriers. By this means, it is possible to reduce the probability that both the I-channel components and Q-channel components of the same symbol hit the fading dip, that is, it is possible to obtain frequency diversity effect and reduce degradation of error rate performances.

Further, transmission diversity techniques that enable significant frequency diversity effect include the cyclic delay diversity technique (CDD, see non-patent document 1) of transmitting the same signals subjected to different cyclic delays on a per antenna basis from a plurality of antennas at the same time.

Then, recently, studies are underway to use OFDM in combination with the above diversity technique in mobile communication systems.

Non-patent Document 1: 3GPP RAN WG1 LTE Adhoc meeting (2006.01) R1-060011 “Cyclic Shift Diversity for E-UTRA DL Control Channels & TP”

### DISCLOSURE OF INVENTION

### Problems to be Solved by the Invention

When OFDM and CDD are used in combination, a plurality of OFDM symbols transmitted in CDD are combined in the channel and received by the receiving side. When the channel has a little fading fluctuation in the frequency domain and is relatively flat, in a combined signal received as such, the peaks and valleys of received power, that is, the subcarriers of increased received power and subcarriers of decreased received power appear periodically one after another due to the cyclic delays in CDD. At this time, if all the symbols or both the I-channel components and Q-channel components mapped to different subcarriers by the frequency diversity technique hit the valleys of received power, frequency diversity effect is lost.

It is therefore an object of the present invention to provide a radio communication apparatus and radio communication method that can prevent loss of frequency diversity effect when CDD and frequency diversity technique are used in combination in multicarrier communications.

### Means for Solving the Problem

The radio communication apparatus of the present invention transmits in cyclic delay diversity a plurality of multicarrier signals each formed with a plurality of subcarriers adopts a configuration including: a plurality of antennas; and a mapping section that maps a plurality of symbols to the plurality of subcarriers at a frequency interval according to a number of the plurality of antennas and an amount of delay in cyclic delay diversity transmission.

### ADVANTAGEOUS EFFECT OF THE INVENTION

According to the present invention, it is possible to prevent loss of frequency diversity effect when CDD and frequency diversity technique are used in combination in multicarrier communications.

### BRIEF DESCRIPTION OF DRAWINGS

FIG. 1 is a block diagram showing a configuration of the radio communication apparatus, according to Embodiment 1 of the present invention;

FIG. 2A illustrates an example of symbol mapping (mapping example 1: transmitting side), according to Embodiment 1 of the present invention;

FIG. 2B illustrates an example of symbol mapping (mapping example 1: receiving side), according to Embodiment 1 of the present invention;

FIG. 3A illustrates an example of symbol mapping (mapping example 2: transmitting side), according to Embodiment 1 of the present invention;

FIG. 3B illustrates an example of symbol mapping (mapping example 2: receiving side), according to Embodiment 1 of the present invention;

FIG. 4A illustrates an example of symbol mapping (mapping example 3: transmitting side), according to Embodiment 1 of the present invention;

FIG. 4B illustrates an example of symbol mapping (mapping example 3: receiving side), according to Embodiment 1 of the present invention;

FIG. 5A illustrates an example of symbol mapping (mapping example 4: transmitting side), according to Embodiment 1 of the present invention;

FIG. 5B illustrates an example of symbol mapping (mapping example 4: receiving side, where M=Mmax), according to Embodiment 1 of the present invention;

FIG. 5C illustrates an example of symbol mapping (mapping example 4: receiving side, where M<Mmax), according to Embodiment 1 of the present invention;

FIG. 6 is a block diagram showing a configuration of the radio communication apparatus, according to Embodiment 2 of the present invention;

FIG. 7A illustrates an example of symbol mapping (transmitting side), according to Embodiment 2 of the present invention;

FIG. 7B illustrates an example of symbol mapping (receiving side), according to Embodiment 2 of the present invention;

FIG. 8 is a block diagram showing a configuration of the radio communication apparatus, according to Embodiment 3 of the present invention;

FIG. 9A illustrates a mapping example of the I-channel components and Q-channel components (transmitting side), according to Embodiment 3 of the present invention;

FIG. 9B illustrates a mapping example of the I-channel components and Q-channel components (receiving side), according to Embodiment 3 of the present invention;

FIG. 10 is a block diagram showing a configuration of the radio communication apparatus, according to Embodiment 4 of the present invention;

FIG. 11A illustrates an example of symbol mapping (transmitting side), according to Embodiment 4 of the present invention;

FIG. 11B illustrates an example of symbol mapping (receiving side), according to Embodiment 4 of the present invention;

FIG. 12 is (a variation of) a block diagram showing a configuration of the radio communication apparatus, according to Embodiment 4 of the present invention;

FIG. 13A illustrates an example of symbol mapping (transmitting side) when a distributed channel is defined by resource blocks; and

FIG. 13B illustrates an example of symbol mapping (receiving side) when a distributed channel is defined by resource blocks.

### BEST MODE FOR CARRYING OUT THE INVENTION

Now, embodiments of the present invention will be described in detail with reference to the accompanying drawings. OFDM will be explained as an example of multicarrier communication schemes below, but the present invention is not limited to OFDM.

### Embodiment 1

In the present Embodiment, a case will be explained where CDD and repetition will be used in combination.

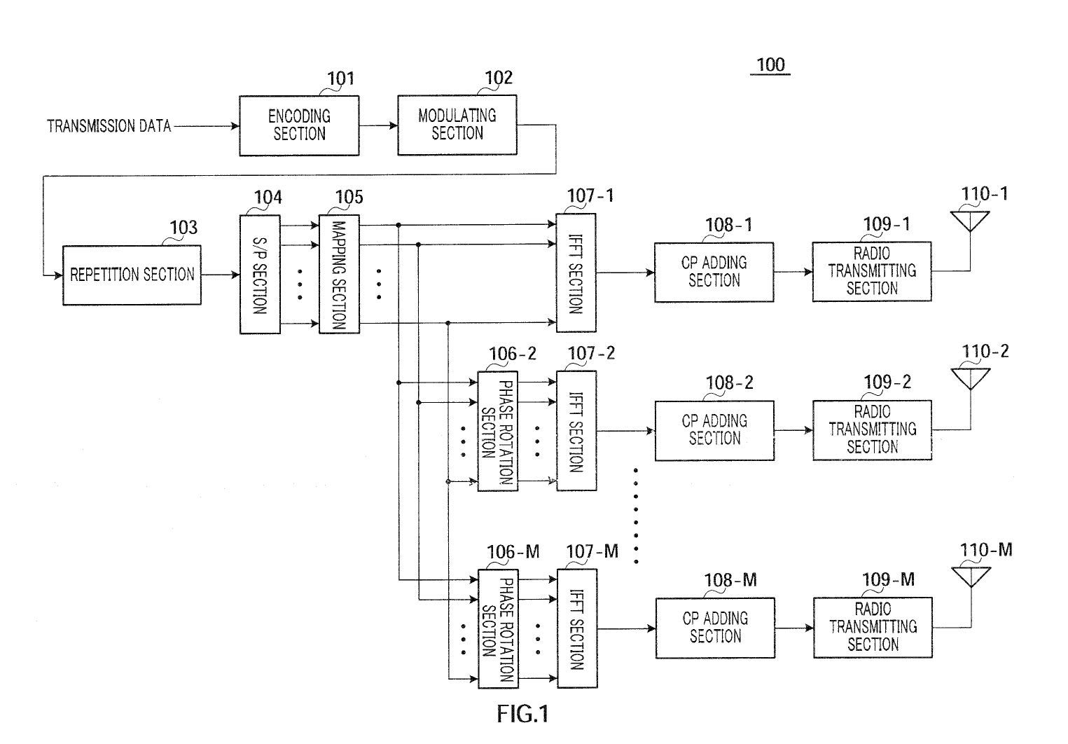

FIG. 1 shows the configuration of radio communication apparatus 100 according to the present embodiment.

Encoding section 101 encodes inputted transmission data (i.e. a bit sequence), and outputs the transmission data to modulating section 102.

Modulating section 102 modulates the transmission data after encoding to generate a symbol, and outputs the symbol to repetition section 103.

Repetition section 103 repeats (i.e. repetition) each symbol to generate a plurality of the same symbols, and outputs the symbols to S/P section 104 (serial-to-parallel conversion section).

S/P section 104 converts the symbol sequence inputted in serial from repetition section 103 to parallel symbol sequences, and outputs them to mapping section 105.

Mapping section 105 maps a plurality of symbols inputted in parallel to a plurality of subcarriers forming an OFDM symbol, which is a multicarrier signal, and outputs the result to IFFT (Inverse Fast Fourier Transform) section 107-1 and phase rotation sections 106-2 to 106-M. The mapping processing will be explained later in detail.

IFFT section 107-1, CP adding section 108-1 and radio transmitting section 109-1 are provided in association with antenna 110-1, to form transmission system 1. Phase rotation sections 106-2 to 106-M, IFFT sections 107-2 to 107-M, CP adding sections 108-2 to 108-M and radio transmitting sections 109-2 to 109-M are provided in association with antennas 110-2 to 110-M, to form transmission systems 2 to M.

IFFT section 107-1 performs the IFFT on a plurality of subcarriers where a plurality of symbols are mapped and converts them to a time domain signal, to generate an OFDM symbol, which is a multicarrier signal. In transmission system 1, a phase rotation section is not provided before IFFT section 107-1, so that IFFT section 107-1 outputs an OFDM symbol in which the amount of delay is zero.

Phase rotation sections 106-2 to 106-M apply phase rotation for CDD transmission, to the symbols mapped to the subcarriers. To be more specific, phase rotation sections 106-2 to 106-M multiply the symbols mapped to subcarrier k (k=1, 2, . . . , and N) of individual OFDM symbols to be transmitted from antennas 110-m (m=2, 3, . . . , and M), by exp((j2πk(m−1)D)/N). M is the number of a plurality of antennas used in CDD transmission, N is the total number of subcarriers forming one OFDM symbol and D is the amount of delay in CDD transmission.

IFFT sections 107-2 to 107-M perform the IFFT on a plurality of subcarriers where a plurality of symbols subjected to the phase rotation are mapped, and convert them to time domain signals, to generate OFDM symbols, which are multicarrier signals. Consequently, OFDM symbols with amounts of delay between D and (M−1)D, are outputted from IFFT section 107-2 to 107-M, respectively.

CP adding sections 108-1 to 108-M add the same signals as the tail parts of OFDM symbols, to the beginning of those OFDM symbols, to provide CPs.

Radio transmitting sections 109-1 to 109-M perform transmission processing including D/A conversion, amplification and up-conversion, on the OFDM symbols with CPs, and transmit M OFDM symbols with amounts of delay between zero and (M−1)D, from antennas 110-1 to 110-M, at the same time. By this means, a plurality of M OFDM symbols are transmitted in CDD from a plurality of M antennas.

Next, the mapping processing in mapping section 105 will be explained in detail with a number of mapping examples.

When a channel has a little fading fluctuation in the frequency domain and is relatively flat, the frequency selectivity due to CDD transmission is predominant, so that, in a combined signal received in the receiving side, the peaks and valleys of received power appear periodically one after another due to the cyclic delays in CDD, and subcarriers intervals between the peaks and valleys of received power (frequency interval) become fixed.

Then, in all of the following mapping examples, mapping section 105 associates a plurality of the same symbols generated by repetition in repetition section 103 with cyclic delay in CDD, and maps the symbols to a plurality of subcarriers forming each OFDM symbol at frequency intervals according to the number of a plurality of antennas and the amount of delay in CDD transmission.

Although cases will be explained with the following mapping examples below where the repetition factor (RF) in repetition section 103 is two and where the same symbols are acquired by twos, the present invention is not limited to a case where RF is two and is applicable to a case where RF is three or more.

### Mapping Example 1

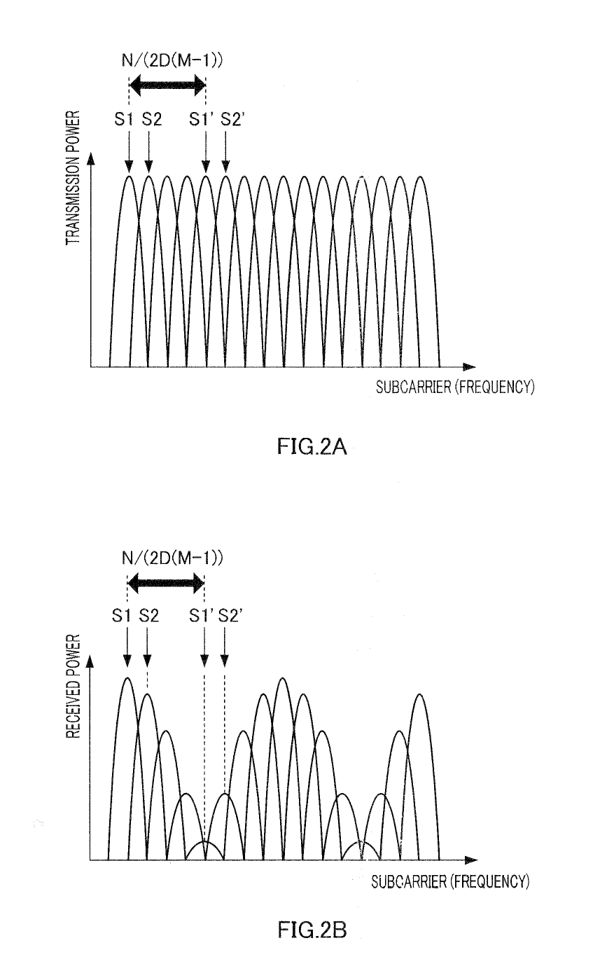

### FIGS. 2A and 2B

Referring to FIG. 2A, in this mapping example, mapping section 105 maps the same symbols S1 and S1′ (S1′ is the same symbol as S1, generated by repeating S1) at N/(2D(M−1)) subcarrier intervals (frequency intervals). Similarly, mapping section 105 maps the same symbol S2 and S2′ (S2′ is the same symbol as S2, generated by repeating S2) at N/(2D(M−1)) subcarrier intervals (frequency intervals).

Phase rotation is not applied to these symbols S1, S1′, S2 and S2′ in transmission system 1 (phase rotation=0) and phase rotation of exp((j2πk(m−1)D)/N) is applied to these symbols in transmission systems 2 to M, and these symbols are transmitted from antennas 1 to M at the same time as M OFDM symbols in which the amounts of delay are zero and between D and (M−1)D.

Then, these M OFDM symbols are combined in the channel and received in the receiving side. The combined signal received as such is shown in FIG. 2B.

As shown in FIG. 2B, in the combined signal, the peaks and valleys of received power appear periodically one after another due to the cyclic delays in CDD. That is, the amount of cyclic delay in CDD is exp((j2πk(m−1)D)/N), so that the intervals between the subcarriers of the maximum received power and the subcarriers of the minimum received power are N/(2D(M−1)).

Accordingly, by adopting the mapping shown in FIG. 2A, as shown in FIG. 2B, symbol S1 is mapped to subcarriers where received power increases and symbol S1′ is mapped to subcarriers where received power decreases. Similarly, symbol S2 is mapped to subcarriers where received power increases, and symbol S2′ is mapped to subcarriers where received power decreases. Consequently, by associating a plurality of the same symbols generated by repetition as above with the amount of cyclic delay in CDD, exp((j2πk(m−1)D)/N) and mapping the symbols to subcarriers at N/(2D(M−1)) subcarrier intervals (frequency intervals), it is possible to prevent the same symbols from all hitting the valleys of received power.

That is, according to this mapping example, when both CDD and repetition are used in combination in multicarrier communications, it is possible to prevent loss of frequency diversity effect obtained by repetition.

### Mapping Example 2

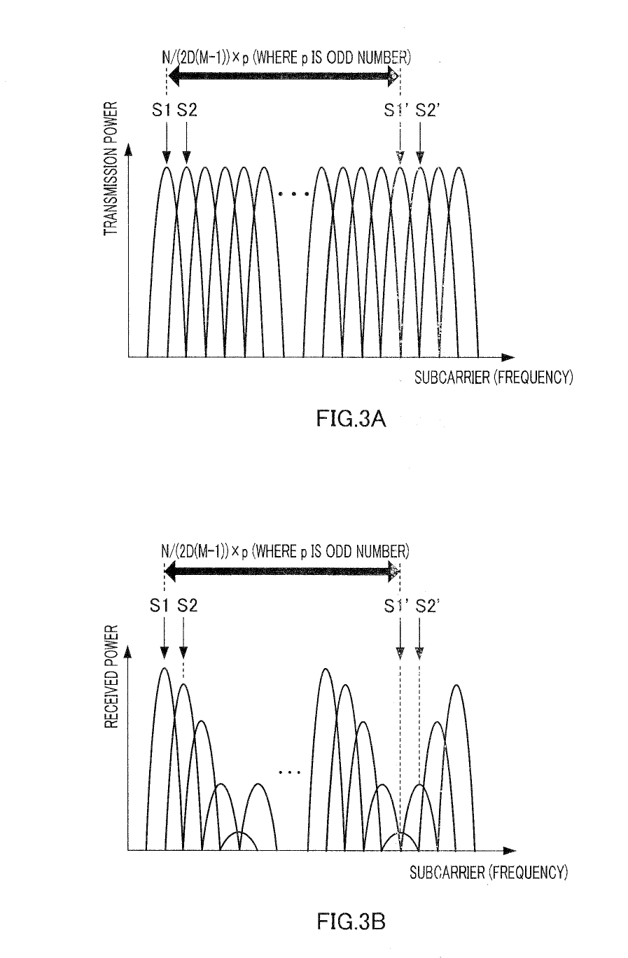

### FIGS. 3A and 3B

According to this mapping example, as shown in FIG. 3A, mapping section 105 maps the same symbols S1 and S1′ at N/(2D(M−1))×p (where p is an odd number) subcarrier intervals (frequency intervals). Similarly, mapping section 105 maps the same symbol S2 and S2′ at N/(2D(M−1))×p subcarrier intervals.

By the mapping as such, as shown in FIG. 3B, symbol S1 is mapped to subcarriers where received power increases, and symbol S1′ is mapped to subcarriers where received power decreases. Similarly, symbol S2 is mapped to subcarriers where received power increases, and symbol S2′ is mapped to subcarriers where received power decreases. Consequently, in this mapping example, by associating a plurality of the same symbols generated by repetition as above with the amount of cyclic delay in CDD, exp((j2πk(m−1)D)/N), and mapping the symbols to subcarriers at N/(2D(M−1))×p subcarrier intervals (frequency intervals), it is possible to prevent a plurality of the same symbols from all hitting the valleys of received power.

That is, according to this mapping example, as in mapping example 1, when both CDD and repetition are used in combination in multicarrier communications, it is possible to prevent loss of frequency diversity effect obtained by repetition. Further, in this mapping example, the subcarrier interval (frequency interval) between the same Symbols is larger than mapping example 1, so that mapping example 2 enables more significant frequency diversity effect than mapping example 1.

### Mapping Example 3

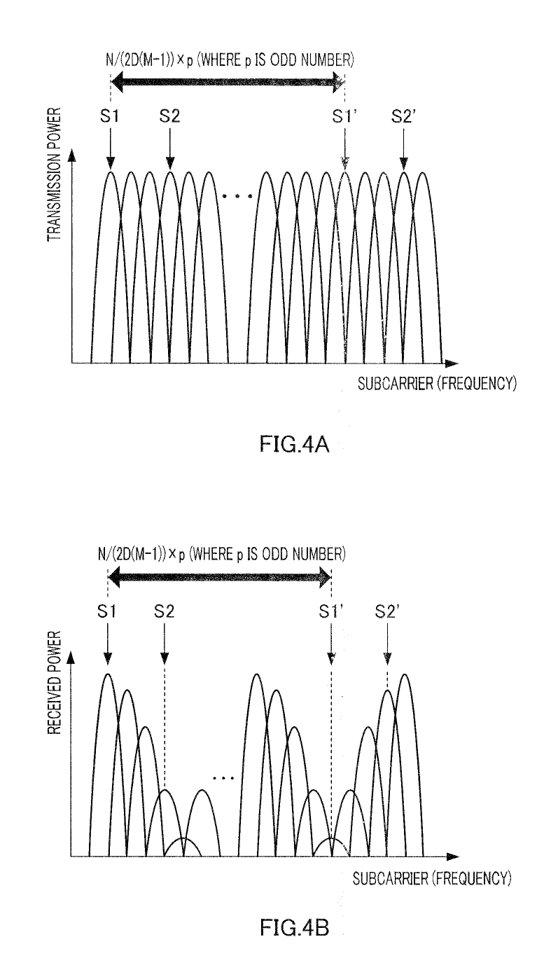

### FIGS. 4A and 4B

Although a case has been explained with mapping example 2 where symbols S1 and S2 are mapped in a consecutive manner (i.e. localized mapping), a case will be explained with this mapping example where symbols S1 and S2 are mapped in a distributed manner (i.e. distributed mapping). This mapping example provides the same advantage as mapping example 2.

### Mapping Example 4

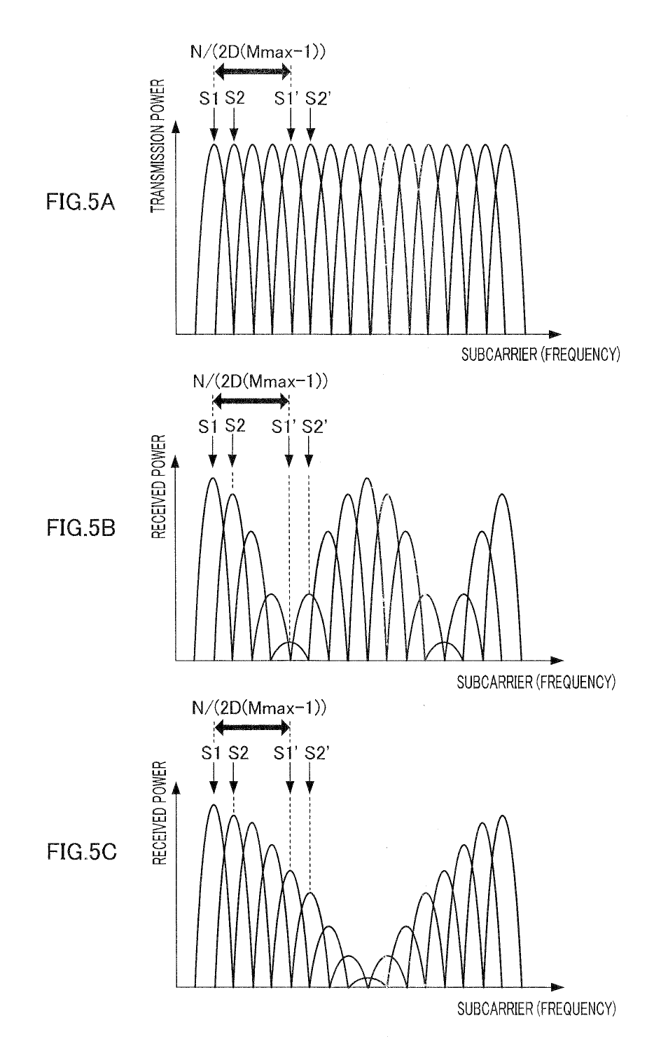

### FIGS. 5A to 5C

Generally, the maximum number of antennas Mmax (a fixed value) that a mobile communication system supports is determined in advance on a per mobile communication system basis. Then, the present mapping example, as shown in FIG. 5A, mapping section 105 maps the same symbols S1 and S1′ at N/(2D(Mmax−1)) subcarrier intervals (frequency intervals). Similarly, mapping section 105 maps the same symbols S2 and S2′ at N/(2D(Mmax−1)) subcarrier intervals (frequency intervals). That is, in this mapping example, the same symbols are mapped at subcarrier intervals (frequency intervals) according to the maximum number of antennas Mmax (fixed value) that a mobile communication system supports, regardless of the number of antennas M actually used in CDD transmission.

When this mapping is used as such, as shown in FIG. 5B, if M=Mmax, symbol S1 is mapped to the subcarriers where received power increases and symbol S1′ is mapped to the subcarriers where received power decreases. Similarly, symbol S2 is mapped to the subcarriers where received power increases and symbol S2′ is mapped to the subcarriers where received power decreases.

On the other hand, the interval between a peak and a valley of received power in a combined signal increases when the number of antennas actually used in CDD transmission decreases, so that, in this mapping example, when M is less than Mmax, as shown in FIG. 5C, compared to a case where M is Mmax, the difference of received power between a plurality of subcarriers, where the same symbols are mapped, decreases. However, even when M is less than Mmax, as in a case where M is Mmax, it is possible to prevent the same symbols from all hitting the valleys of received power.

Consequently, in this mapping example, by associating a plurality of the same symbols generated by repetition as above with the amount of cyclic delay in CDD, exp((j2πk(m−1)D)/N) and mapping the symbols to subcarriers at N/(2D(Mmax−1)) subcarrier intervals (frequency intervals), it is possible to prevent a plurality of the same symbols from all hitting the dips of received power.

That is, according to this mapping example, as in mapping example 1, when both CDD and repetition are used in combination in multicarrier communications, it is possible to prevent loss of frequency diversity effect obtained by repetition. Further, in this mapping example, the mapping interval between the same symbols is uniquely determined according to the maximum number of antennas that the mobile communication system supports, regardless of the number of antennas actually used in CDD transmission, so that a simpler mobile communication system than in mapping example 1 can be realized.

### Mapping Example 5

This mapping example sets maximum amount of delay Dmax that does not depend on the number of antennas used in CDD transmission and uses the above amount of delay D as D=Dmax/(M−1). That is, in this mapping example, the amount of delay D decreases when the number of antennas used in CDD transmission increases. As such, when D=Dmax/(M−1) is used in the mapping example, to prevent the same symbols from all hitting valleys of received power, mapping section 105 maps the same symbols at N/2Dmax subcarrier intervals (frequency intervals) regardless of the number of antennas used in transmission in CDD.

In this way, according to this mapping example, the mapping interval between the same symbols does not depend on the number of antennas actually used in CDD transmission and is uniquely determined by the maximum amount of delay Dmax that the mobile communication system supports, so that as in mapping example 4, a simpler mobile communication system than in mapping example 1 can be realized.

Mapping examples 1 to 5 have been explained above.

In this way, according to the present embodiment, when both CDD and repetition are used in combination in multicarrier communications, it is possible to prevent loss of frequency diversity effect obtained by repetition.

### Embodiment 2

In the present embodiment, a case will be explained where CDD and distributed transmission are used in combination.

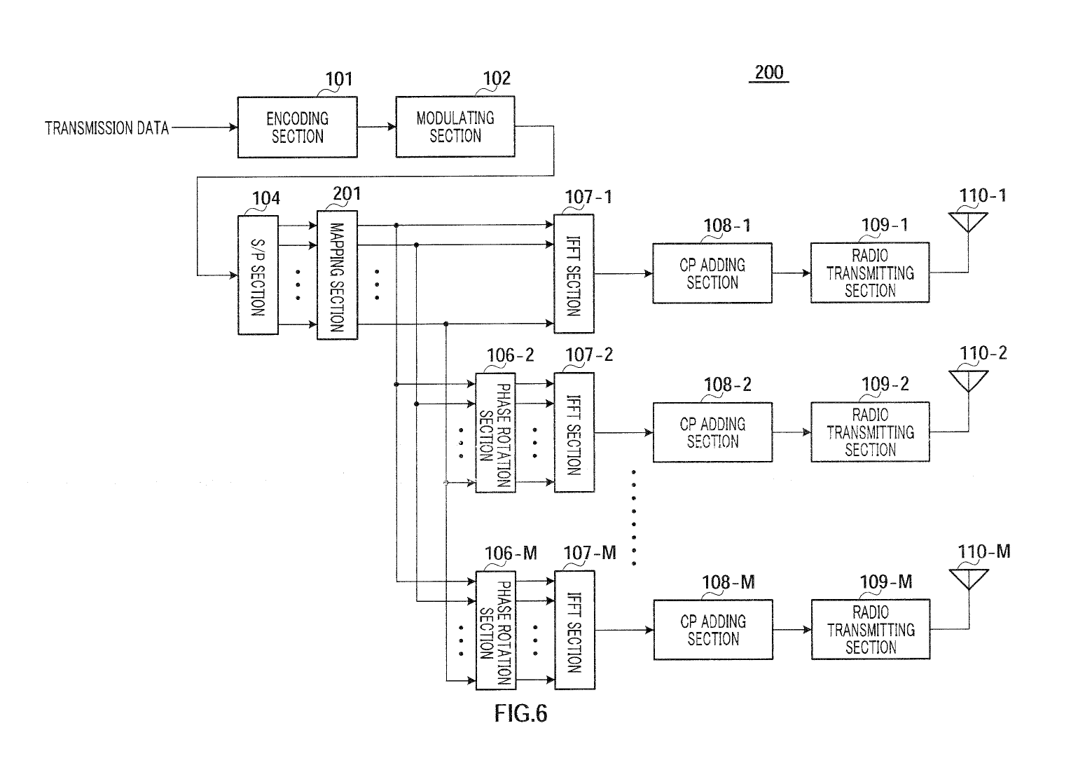

FIG. 6 shows the configuration of radio communication apparatus 200 according to the present embodiment. In FIG. 6, the components having the same functions as FIG. 1 will be assigned the same reference numerals and overlapping descriptions will be omitted.

Modulating section 102 modulates transmission data after encoding to generate a symbol, and outputs the symbol to S/P section 104.

S/P section 104 converts a symbol sequence inputted in serial from modulating section 102 to parallel symbol sequences, and outputs them to mapping section 201.

Mapping section 201 maps a plurality of symbols inputted in parallel to a plurality of subcarriers forming an OFDM symbol, which is a multicarrier signal, and outputs them to IFFT section 107-1 and phase rotation sections 106-2 to 106-M.

Next, mapping processing in mapping section 201 will be explained.

As described above, when a channel has a little fading fluctuation in the frequency domain and is relatively flat, the frequency selectivity due to CDD transmission is predominant, so that, in a combined signal received in the receiving side, the peaks and valleys of received power appear periodically one after another due to the cyclic delays in CDD, and subcarrier intervals between the peaks and valleys of received power (frequency interval) become fixed.

Then, mapping section 201 associates a plurality of symbols in the same distributed channel with cyclic delay in CDD, and maps the symbols to a plurality of subcarriers forming individual OFDM symbols at frequency intervals according to the number of a plurality of antennas and the amount of delay in CDD transmission.

Although a case will be explained as an example with the following explanation below where the OFDM symbol is formed with subcarriers f₁ to f₁₆ the present invention by no means limits the number of subcarriers.

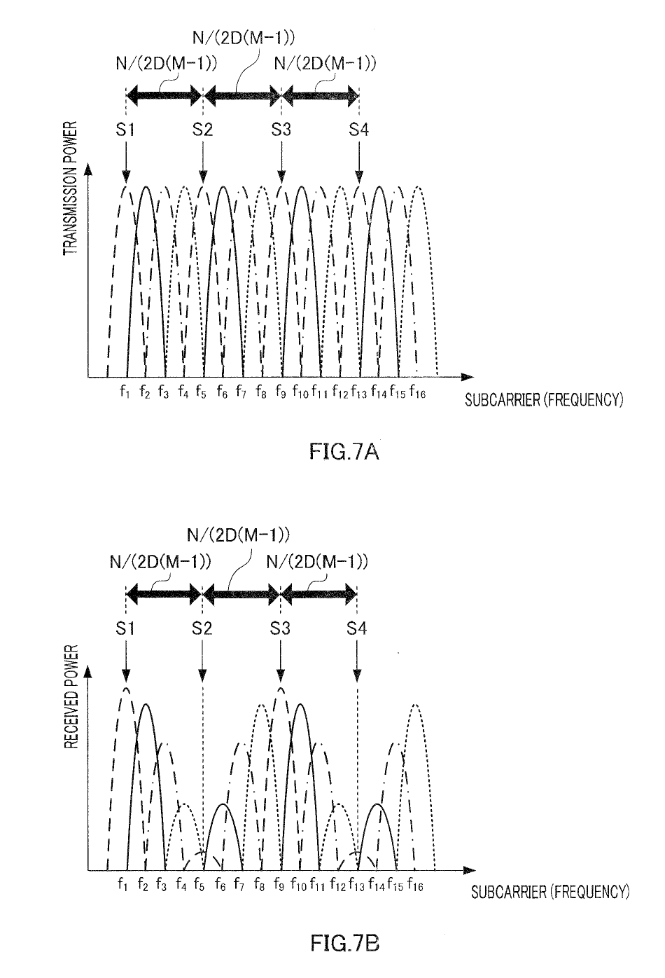

In the present embodiment, as shown in FIG. 7A, mapping section 201 maps a plurality of different symbols S1, S2, S3 and S4 at N/(2D(M−1)) subcarrier intervals (frequency intervals). Symbols S1, S2, S3 and S4 are transmitted to the same communicating party. Moreover, here, distributed channel #1 is formed with subcarriers f₁, f₅, f₉ and f₁₃ according to N/(2D(M−1)) subcarrier intervals. That is, mapping section 201 maps a plurality of symbols S1, S2, S3 and S4 of distributed channel #1 to subcarriers f₁, f₅, f₉, and f₁₃, respectively, at N/(2D(M−1)) subcarrier intervals (frequency intervals) from subcarrier f₁.

Similarly, distributed channel #2 is formed with subcarriers f₂, f₆, f₁₀ and f₁₄, distributed channel #3 is formed with subcarriers f₃, f₇, f₁₁ and f₁₅, and distributed channel #4 is formed with subcarriers f₄, f₈, so that mapping section 201 maps a plurality of symbols of distributed channel #2 at N/(2D(M−1)) subcarrier intervals (frequency intervals) from subcarrier f₂, a plurality of symbols of distributed channel #3 at N/(2D(M−1)) subcarrier intervals (frequency intervals) from subcarrier f₃, and a plurality of symbols of distributed channel #4 at N/(2D(M−1)) subcarrier intervals (frequency intervals) from subcarrier f₄.

In this way, mapping section 201 maps a plurality of symbols of the same distributed channel at N/(2D(M−1)) subcarrier intervals.

Hereinafter, distributed channel #1 will be focused and explained.

Phase rotation is not applied to symbols S1, S2, S3 and S4 in transmission system 1 (phase rotation=0) and phase rotation of exp((j2πk(m−1)D)/N) is applied to the symbols in transmission systems 2 to M, and the symbols are transmitted from antennas 1 to M at the same time as M OFDM symbols in which amounts of delay are zero and between D and (M−1)D.

Then, these M OFDM symbols are combined in the channel and received in the receiving side. The combined signal received as such is shown in FIG. 7B.

As shown in FIG. 7B, in the combined signal, the peaks and valleys of received power appear periodically one after another due to the cyclic delays in CDD. That is, the amount of cyclic delay in CDD is exp((j2πk(m−1)D)/N), so that the subcarrier intervals between the subcarriers of the maximum received power and the subcarriers of the minimum received power are N/(2D(M−1)).

Accordingly, by adopting the mapping shown in FIG. 7A, as shown in FIG. 7B, symbol S1, 52, S3 and S4 are mapped to subcarriers where received power increases and where received power decreases in a distributed manner. Consequently, by associating a plurality of the symbols of the same distributed channel as above with the amount of the cyclic delay in CDD, exp((j2πk(m−1)D)/N) and mapping the symbols to subcarriers at N/(2D(M−1)) subcarrier intervals (frequency intervals), it is possible to prevent the symbols from all hitting the valleys of the received power. The same applies to the other distributed channels #2 to #4.

With the present embodiment, the same mapping example as mapping example 1 of Embodiment 1 has been explained, and the present embodiment also adopts the same mapping as mapping examples 2 to 5 of Embodiment 1 even when CDD and distributed transmission are used in combination.

In this way, according to the present embodiment, when both CDD and distributed transmission are used in combination in multicarrier communications, it is possible to prevent loss of frequency diversity effect obtained by distributed transmission.

### Embodiment 3

In the present embodiment, a case will be explained where CDD and modulation diversity are used in combination.

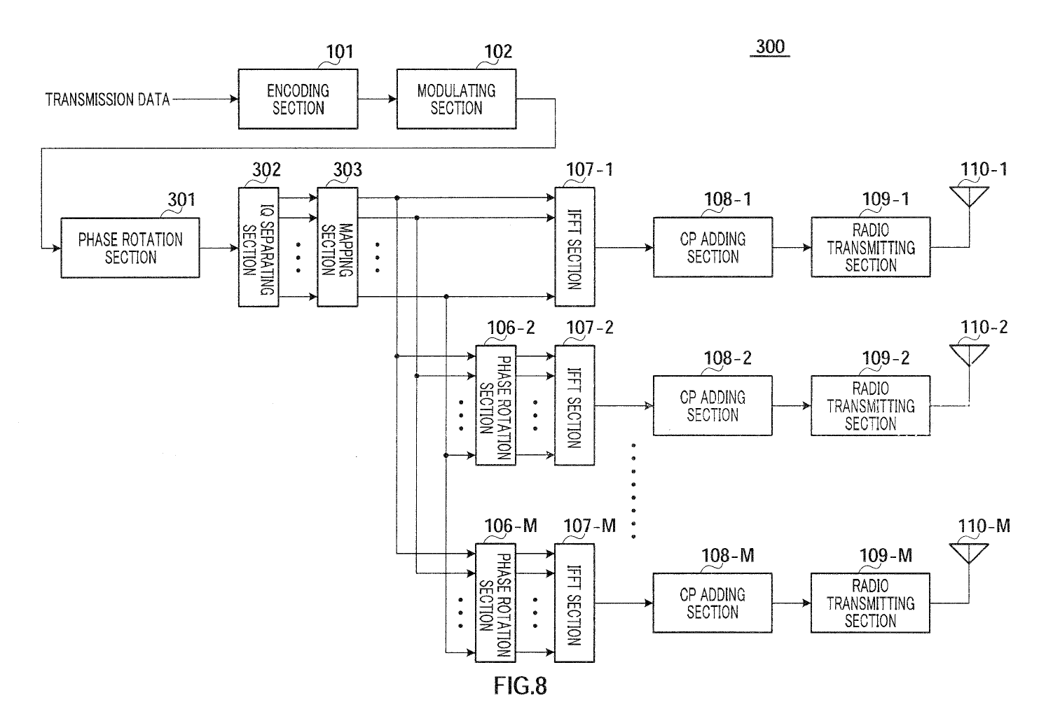

FIG. 8 shows the configuration of radio communication apparatus 300 according to the present embodiment. In FIG. 8, the components having the same functions as FIG. 1 will be assigned the same reference numerals and overlapping descriptions will be omitted.

Modulating section 102 modulates transmission data after encoding to generate a symbol, and outputs the symbol to phase rotation section 301.

Phase rotation section 301 applies different amounts of phase rotations to the symbols inputted from modulating section 102 on a per symbol basis, and outputs the symbols to IQ separating section 302.

IQ separating section 302 separates the symbols subjected to the phase rotation into the I-channel components and Q-channel components, and outputs the I-channel components and Q-channel components to mapping section 303.

Mapping section 303 maps the I-channel components and Q-channel components inputted in parallel to a plurality of subcarriers forming an OFDM symbol, which is a multicarrier signal, and outputs the result to IFFT section 107-1 and phase rotation sections 106-2 to 106-M.

Next, mapping processing in mapping section 303 will be explained.

As described above, when a channel has a little fading fluctuation in the frequency domain and is relatively flat, the frequency selectivity due to CDD transmission is predominant, so that, in a combined signal received in the receiving side, the peaks and valleys of received power appear periodically one after another due to the cyclic delays in CDD, and subcarrier intervals between the peaks and valleys of received power (frequency interval) become fixed.

Then, mapping section 303 associates the I-channel component and Q-channel component of the same symbol with cyclic delay in CDD, and maps the components to a plurality of subcarriers forming individual OFDM symbols at frequency intervals according to the number of a plurality of antennas and the amount of delay in CDD transmission.

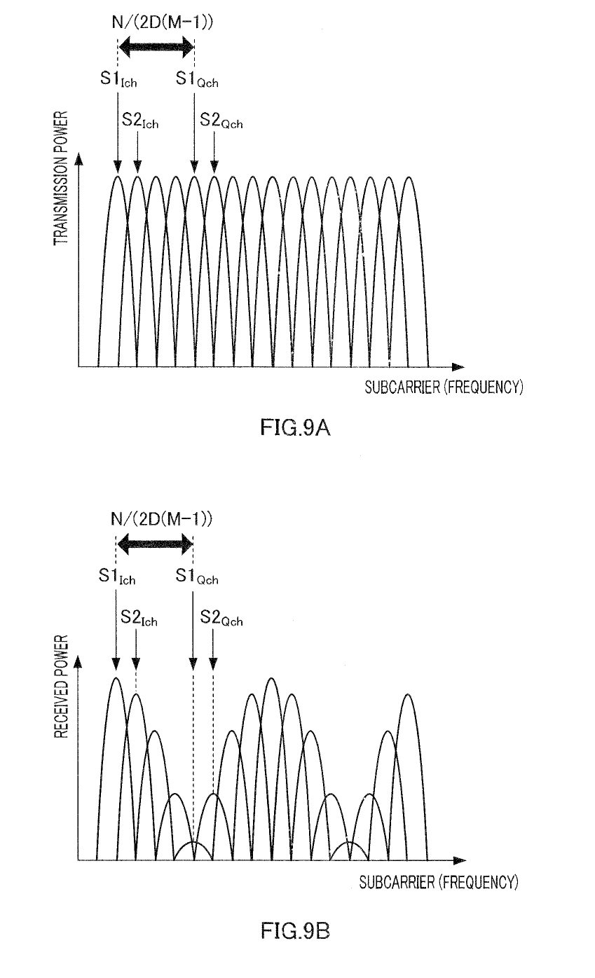

Referring to FIG. 9A, in the present embodiment, mapping section 303 maps S1_{Ich}, which is the I-channel component of symbol S1, and S1_{Qch}, which is the Q-channel component of symbol S1, at N/(2D(M−1)) subcarrier intervals (frequency intervals). Similarly, mapping section 303 maps S2_{Ich}, which is the I-channel component of symbol S2, and S2_{Qch}, which is the Q-channel component of symbol S2 at N/(2D(M−1)) subcarrier intervals (frequency intervals). That is, mapping section 303 maps the I-channel component and the Q-channel component of the same symbol at N/(2D(M−1)) subcarrier intervals (frequency intervals).

Phase rotation is not applied to these S1_{Ich}, S1_{Qch}, S2_{Ich} and S2_{Qch} in transmission system 1 (phase rotation=0) and phase rotation of exp((j2πk(m−1)D)/N) is applied to these components in transmission systems 2 to M, and these components are transmitted from antennas 1 to M at the same time as M OFDM symbols in which the amounts of delay are zero and between D and (M−1)D.

Then, these M OFDM symbols are combined in the channel and received in the receiving side. The combined signal received as such is shown in FIG. 9B.

As shown in FIG. 9B, in the combined signal, the peaks and valleys of received power appear periodically one after another due to the cyclic delays in CDD. That is, the amount of cyclic delay in CDD is exp((j2πk(m−1)D)/N), so that the subcarrier intervals between the subcarriers of the maximum received power and the subcarriers of the minimum received power are N/(2D(M−1)).

Accordingly, by adopting the mapping shown in FIG. 9A, as shown in FIG. 9B, S1_{Ich} is mapped to subcarriers where received power increases and S1_{Qch} is mapped to subcarriers where received power decreases. Similarly, S2_{Ich} is mapped to subcarriers where received power increases and S2_{Qch} is mapped to subcarriers where received power decreases. Consequently, by associating the I-channel component and the Q-channel component separated from the same symbol as above with the amount of cyclic delay in CDD, exp ((j2πk(m−1)D)/N) and mapping the symbols to subcarriers at N/(2D(M−1)) subcarrier intervals (frequency intervals), it is possible to prevent both the I-channel component and Q-channel component separated from the same symbol from all hitting the valleys of received power.

With the present embodiment, the same mapping example as mapping example 1 of Embodiment 1 has been explained, and the present embodiment also adopts the same mapping as mapping examples 2 to 5 of Embodiment 1 even when CDD and modulation diversity are used in combination.

In this way, according to the present embodiment, when both CDD and modulation diversity are used in combination in multicarrier communications, it is possible to prevent loss of frequency diversity effect obtained by modulation diversity.

### Embodiment 4

In the present embodiment, when CDD and repetition are used in combination, the amount of delay in CDD transmission is set according to the intervals between a plurality of subcarriers where a plurality of the same symbols are mapped.

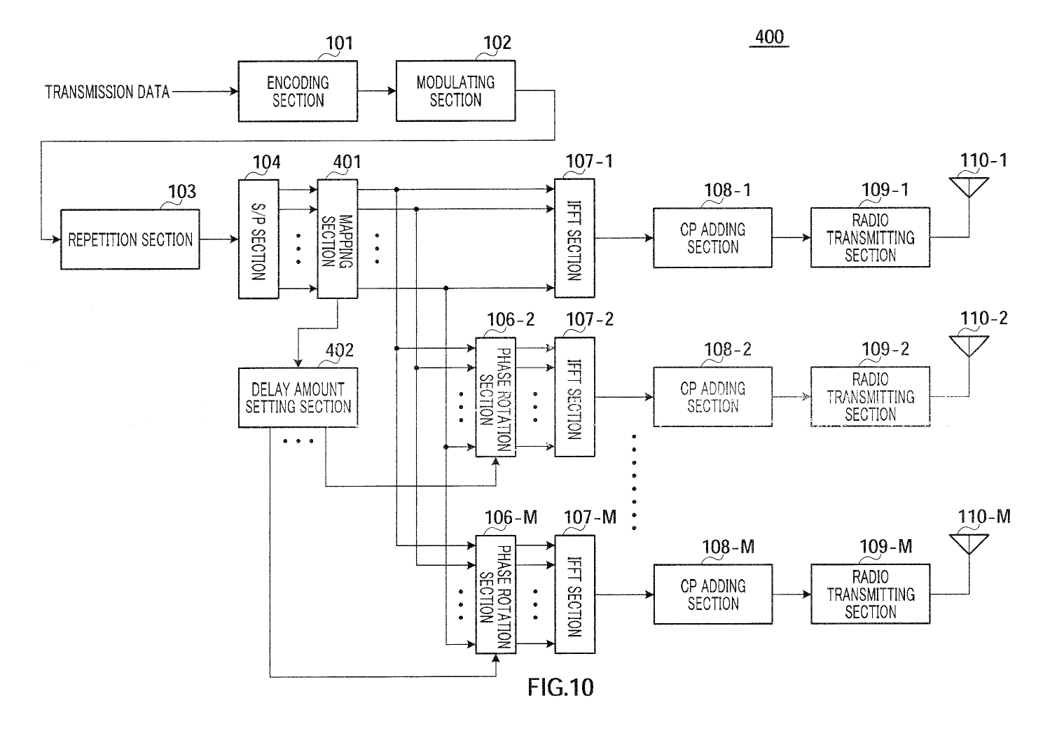

FIG. 10 shows the configuration of radio communication apparatus 400 according to the present embodiment. In FIG. 10, the components having the same functions as FIG. 1 will be assigned the same reference numerals and overlapping descriptions will be omitted.

Mapping section 401 maps a plurality of symbols inputted in parallel from S/P section 104 to a plurality of subcarriers forming an OFDM symbol, which is a multicarrier signal, and outputs the result to IFFT section 107-1 and phase rotation sections 106-2 to 106-M. At this time, mapping section 401 maps a plurality of the same symbols to a plurality of subcarriers at subcarrier intervals of L. Further, mapping section 401 outputs subcarrier interval L to delay amount setting section 402.

Subcarrier interval L is set in advance for each communication system, or is reported from an upper layer station. When radio communication apparatus 400 is equipped with a radio communication mobile station apparatus, the radio communication base station apparatus serves as the upper layer station, and, when radio communication apparatus 400 is equipped with a radio communication base station apparatus, the radio channel control station apparatus serves as the upper layer station.

Delay amount setting section 402 sets the amount of delay D in CDD transmission to phase rotation sections 106-2 to 106-M. Delay amount setting section 402 finds the amounts of delay D for phase rotation sections 106-2 to 106-M by N/(2L(M−1)) and set the amounts of delay D in phase rotation sections 106-2 to 106-M.

Phase rotation sections 106-2 to 106-M apply phase rotation for CDD transmission to the symbols mapped to the subcarriers. To be more specific, phase rotation sections 106-2 to 106-M multiply the symbols mapped to subcarrier k (k=1, 2, . . . , and N) of individual OFDM symbols to be transmitted from antennas 110-m (m=2, 3, . . . , and M), by exp((j2πk(m−1)D)/N). D is the amount of delay in CDD transmission set by delay amount setting section 402.

As described above, when a channel has a little fading fluctuation in the frequency domain and is relatively flat, the frequency selectivity due to CDD transmission is predominant, so that, in a combined signal received in the receiving side, the peaks and valleys of received power appear periodically one after another due to the cyclic delays in CDD, and subcarrier intervals between the peaks and valleys of received power (frequency interval) become fixed.

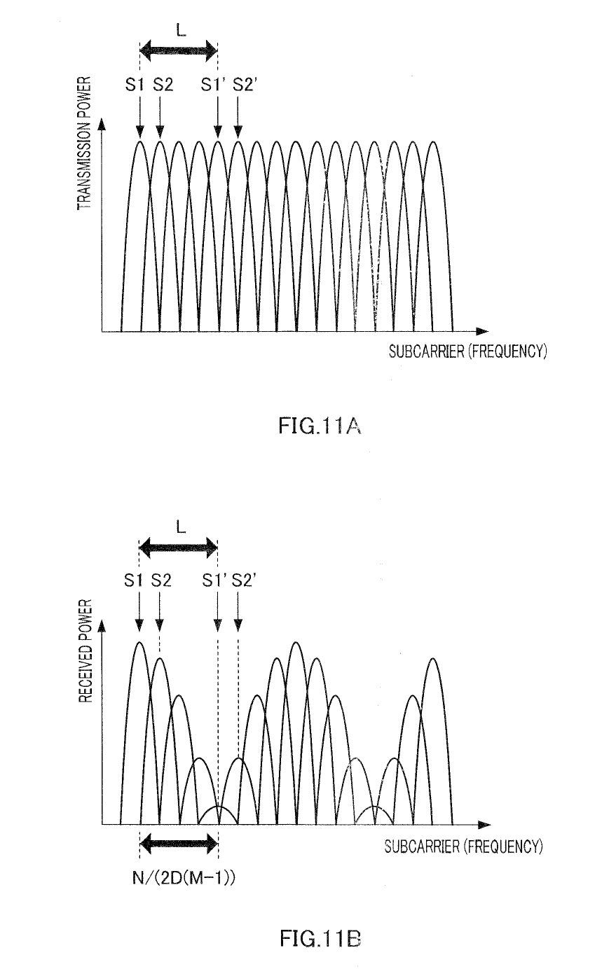

Then, in the present embodiment, as shown in FIG. 11A, when the same symbols S1 and S1′ are mapped at subcarrier interval L (frequency interval) and the same symbols S2 and S2′ are mapped at subcarrier interval L (frequency interval), phase rotation is not applied to these symbols S1, S1′, S2 and S2′ in transmission system (phase rotation=0) and phase rotation of exp((j2πk(m−1)D)/N) is applied to these symbols in transmission systems 2 to M, and these symbols are transmitted from antennas 1 to M at the same time as M OFDM symbols in which the amounts of delay are zero and between D and (M−1)D. Further, D is the amount of delay found by N/(2L(M−1)) in delay amount setting section 402. By finding the amount of delay D in CDD transmission as such, it is possible to match subcarrier interval L with the interval of frequency selectivity due to CDD transmission.

Then, these M OFDM symbols are combined in the channel and received in the receiving side. The combined signal received as such is shown in FIG. 11B.

As shown in FIG. 11B, in the combined signal, the peaks and valleys of received power appear periodically one after another due to the cyclic delays in CDD. That is, the amount of cyclic delay in CDD is exp((j2πk(m−1)D)/N), so that the subcarrier intervals between the subcarriers of the maximum received power and the subcarriers of the minimum received power are N/(2D(M−1)).

Accordingly, by finding the amount of delay D in CDD transmission based on subcarrier intervals of L shown in FIG. 11A, as shown in FIG. 11B, symbol S1 is mapped to subcarriers where received power increases and symbol S1′ is mapped to subcarriers where received power decreases. Similarly, symbol S2 is mapped to subcarriers where received power increases and symbol S2′ is mapped to subcarriers where received power decreases. Consequently, as described above, by setting the amount of delay, N/(2L(M−1) in association with subcarrier interval L between a plurality of the same symbols generated by repetition, it is possible to prevent the same symbols from all hitting the valleys of the received power.

In this way, according to the present embodiment, transmission is carried out with the amount of delay D according to subcarrier intervals of L, so that, it is possible to prevent loss of frequency diversity effect obtained by repetition regardless of the value of subcarrier intervals of L.

The amount of delay D may also be calculated by N/(2L(M−1)×1/p) (where p is an odd number).

With the present embodiment, although repetition has been explained as an example of a frequency diversity technique to be combined with CDD, the present embodiment may be implemented using distributed transmission or modulation diversity as the frequency diversity technique as described above. For example, when distributed transmission is used as the frequency diversity technique, the subcarrier interval between S1 and S2, the subcarrier interval between S2 and S3, and the subcarrier interval between S3 and S4 in FIG. 7A, are L. Moreover, when modulation diversity is used as the frequency diversity technique, the subcarrier interval between S1_{Ich} and S1_{Qch}, and the subcarrier interval between S2_{Ich} and S2_{Qch} in FIG. 9A, are L.

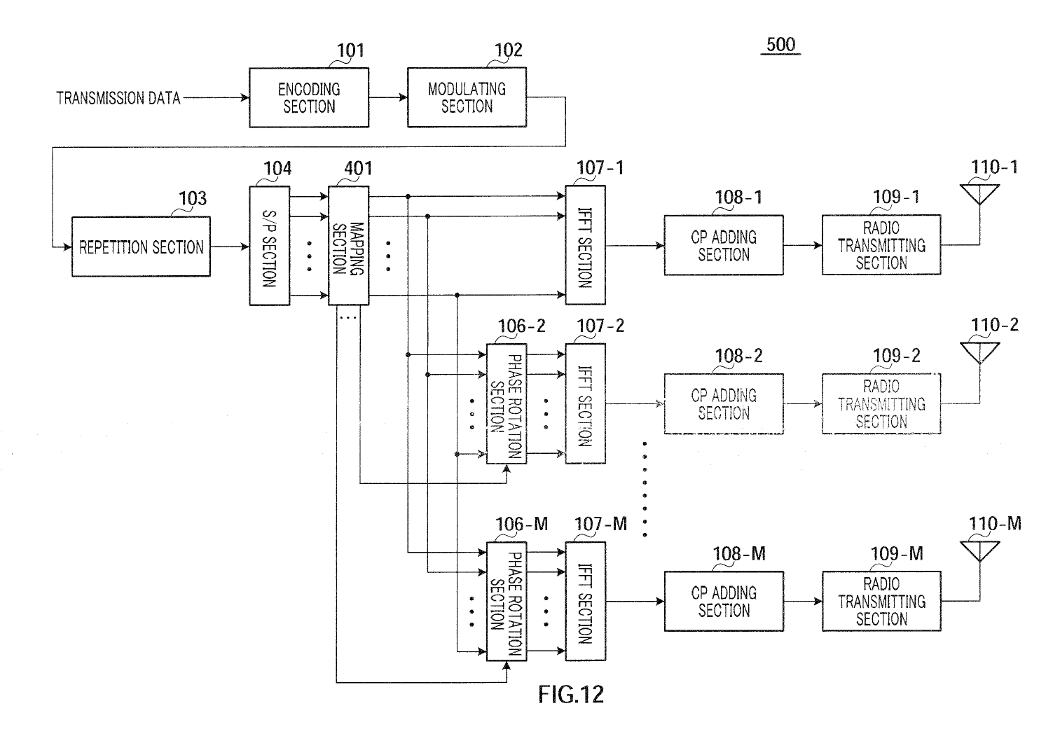

Moreover, although a configuration has been explained above where delay amount setting section 402 finds the amount of delay D and set it in phase rotation sections 106-2 to 106-M (FIG. 10), and, the configuration shown in FIG. 12 may also be adopted instead of FIG. 10. In radio communication apparatus 500 shown in FIG. 12, mapping section 401 outputs subcarrier interval L to phase rotation sections 106-2 to 106-M, and, phase rotation sections 106-2 to 106-M find the amounts of delay D by N/(2L(M−1)) and then multiply the symbols mapped to subcarrier k (k=1, 2, . . . , and N) in OFDM symbols to be transmitted from antennas 110-m (m=2, 3, . . . , and M), by exp((j2πk(m−1)D)/N). In this way, the amount of delay D may be calculated based on subcarrier interval L in phase rotation sections 106-2 to 106-M, without providing delay amount setting section 402.

The embodiments of the present invention have been explained.

The radio communication apparatus according to the present invention can be mounted in a radio communication base station apparatus or a radio communication mobile station apparatus in a mobile communication system, and, when it is mounted, the radio communication base station apparatus or the radio communication mobile station apparatus that have the above working effects and advantages can be provided.

Although the same symbols are mapped to different subcarriers in the same OFDM symbol in the above mapping examples, the same symbols may be mapped to different subcarriers in different OFDM symbols at the above subcarrier intervals.

Even if the same symbols are not accurately mapped at the subcarrier intervals, it is still possible to provide an advantage of sufficient transmission diversity For example, according to mapping example 1 of Embodiment 1, if N is 64, M is 2 and D is 2, the subcarrier interval is 16. However, an advantage of sufficient transmission diversity can be provided even if this interval is 15 or 17. If the subcarrier interval between subcarriers where the same symbols are mapped is within approximately ±20% of an accurate value, there is no difference in the obtained transmission diversity. Further, if the subcarrier, interval found by calculation is not an integer, the subcarrier interval is may be truncated or rounded up to an integer.

CDD may be referred to as “CSD (cyclic shift diversity).” A CP may be referred to as “guard interval (GI).” The subcarrier may be referred to as a “tone.” A base station and a mobile station may be referred to as “Node B,” and “UE.”

Moreover, a distributed channel may be referred to as “diversity channel.” Further, the distributed channel may be defined by a resource block (RB), where a plurality of subcarriers are bound. In this case, the distributed channel may be referred to as distributed RB or DRB.

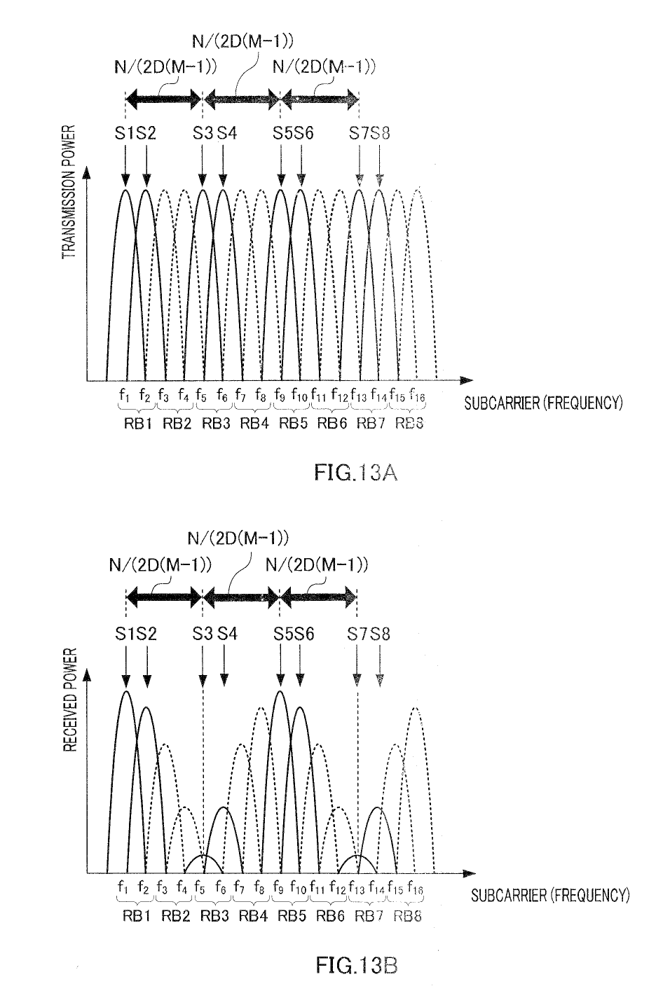

Moreover, when the distributed channel is defined by resource blocks, the same working effect can be provided by setting the subcarrier interval between distributed RBs in the above subcarrier interval. For example, as shown in FIGS. 13A and 13B, when a plurality of RB 1 to RB8 are each formed with two subcarriers, by forming one distributed channel from N/(2D(M−1)) RB intervals, that is, from 4 RBs of RB 1, RB 3, RB 5 and RB 7, it is possible to provide the same advantage of above Embodiment 2.

Moreover, although cases have been described with the embodiments above where the present invention is configured by hardware, the present invention may be implemented by software.

Each function block employed in the description of the aforementioned embodiment may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2006-156432, filed on Jun. 5, 2006, and Japanese Patent Application No. 2006-316145, filed on Nov. 22, 2006 including the specifications, drawings and abstracts, are incorporated herein by reference in their entirety.

### INDUSTRIAL APPLICABILITY

The present invention is applicable to, for example, mobile communication systems.

1. A radio communication apparatus transmits in cyclic delay diversity a plurality of multicarrier signals each formed with a plurality of subcarriers, comprising:
a plurality of antennas; and
a mapping section that maps a plurality of symbols to the plurality of subcarriers at a frequency interval according to a number of the plurality of antennas and an amount of delay in cyclic delay diversity transmission.

2. The radio communication apparatus according to claim 1, further comprising a repeating section that repeats a symbol to generate a plurality of the same symbols,
wherein the mapping section maps the plurality of the same symbols to the plurality of subcarriers at the frequency interval.

3. The radio communication apparatus according to claim 1, wherein the mapping section maps a plurality of symbols of the same distributed channel to the plurality of subcarriers at the frequency interval.

4. The radio communication apparatus according to claim 1, further comprising a plurality of M antennas,
wherein the mapping section maps the plurality of symbols to the plurality of subcarriers at a frequency interval of N/(2D(M−1)), where N is the number of the subcarriers and D is the amount of delay.

5. The radio communication apparatus according to claim 1, further comprising a plurality of M antennas,
wherein the mapping section maps the plurality of symbols to the plurality of subcarriers at a frequency interval of an odd multiple of N/(2D(M−1)), where N is the number of the subcarriers and D is the amount of delay.

6. A radio communication base station apparatus comprising the radio communication apparatus according to claim 1.

7. A radio communication mobile station apparatus comprising the radio communication apparatus according to claim 1.

8. A radio communication method of transmitting in cyclic delay diversity a plurality of multicarrier signals each formed with a plurality of subcarriers using a plurality of antennas, the method comprising:
mapping a plurality of symbols to the plurality of subcarriers at a frequency interval according to a number of the plurality of antennas and an amount of delay in cyclic delay diversity transmission.
